(19) United States
(12) Patent Application Publication
(10) Pub. No.: US 2006/0006692 A1
(43) Pub. Date: Jan. 12, 2006

(54) Driving device of opening and closing member

(75) Inventors: Koichi Takahashi, Nagoya-shi (JP); Yoshinori Iwase, Chiryu-shi (JP); Seika Matsui, Chiryu-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA

(21) Appl. No.: 11/175,164

(22) Filed: Jul. 7, 2005

(30) Foreign Application Priority Data
Jul. 8, 2004 (JP) 2004-202213

(51) Int. Cl. B60J 5/10

(52) U.S. Cl. 296/146.4

(57) ABSTRACT

A driving device of opening and closing member for automatically controlling the opening and closing member includes a driving means including a driving motor that drives an opening and closing member to open or close, and a clutch, a position detecting means for detecting a relative position of the opening and closing member, and a drive controlling means for controlling an operation of the driving means by using an output information from the position detecting means. When the drive controlling means is reset, the clutch is brought in a disengagement state, and the drive controlling means specifies a present position of the opening and closing member by using an output information from the position detecting means after the reset of the drive controlling means so as to control a subsequent automatic opening and closing operation of the opening and closing member.

### CROSS REFERENCE TO RELATED APPLICATIONS

This application is based on and claims priority under 35 U.S.C. § 119 to Japanese Patent Application No. 2004-202213, filed on Jul. 8, 2004, the entire content of which is incorporated herein by reference.

### FIELD OF THE INVENTION

This invention generally relates to a driving device of opening and closing member for an automatically controlling the opening and closing member.

### BACKGROUND

A known driving device of opening and closing member for automatically opening and closing an opening and closing member for a vehicle includes a position detecting means for sequentially detecting a relative position of the opening and closing member. The driving device of opening and closing member controls the opening and closing member based on the detected position information. Such a driving device of opening and closing member is disclosed, as a back door for a vehicle, in Japanese Patent Laid-Open Publication No. 2001-199243. According to the opening and closing member disclosed, a wrong recognition of position may be caused due to repetition of opening and closing operation of the opening and closing member. In order to correct such a wrong recognition, a position information is initialized by means of a latch switch of the opening and closing member at a time of the opening and closing member in a fully closed position.

The driving device of opening and closing member disclosed includes a drive controlling means for controlling an automatic opening and closing operation of the opening and closing member. However, the drive controlling means may sometimes fail to recognize a position information of the opening and closing member. For example, in cases where a power supply voltage drops and then the drive controlling means is reset, a moving amount of the opening and closing member is not recognized while the drive controlling means is under reset, thereby causing a wrong position information after the reset is completed. Particularly in case of a power back door and the like, a door may widely move during a reset occurrence because of a reaction of a damper arranged adjacent to a driving mechanism. Thus, misalignment amount of a position may be large. In such circumstances, since the opening and closing member is forcedly driven, a mechanical portion of the opening and closing member may be damaged or an operation direction of the opening and closing member may be wrongly performed.

Therefore, according to the driving device of opening and closing member disclosed, when the reset occurs in the drive controlling means, a position information of the position detecting means needs to be initialized by using, for example, a switch that can detect an absolute position of the opening and closing member when the opening and closing member is at a certain position.

Thus, a need exists for a driving device of opening and closing member that can promptly correct misalignment of position, i.e. wrong position information, in cases where a reset occurs in a drive controlling means of the opening and closing member.

### SUMMARY OF THE INVENTION

According to an aspect of the present invention, a driving device of opening and closing member includes a driving means for automatically controlling the opening and closing member including a driving motor that drives an opening and closing member to open or close, and a clutch disposed between the driving motor and the opening and closing member, a position detecting means for detecting a [relative] position of the opening and closing member, and a drive controlling means for controlling an operation of the driving means by using an output information from the position detecting means. When the drive controlling means is reset, the clutch is brought in a disengagement state, and the drive controlling means specifies a present position of the opening and closing member by using an output information from the position detecting means after the reset of the drive controlling means so as to control a subsequent automatic opening and closing operation of the opening and closing member.

### BRIEF DESCRIPTION OF THE DRAWINGS

The foregoing and additional features and characteristics of the present invention will become more apparent from the following detailed description considered with reference to the accompanying drawings, wherein:

FIG. 1 is a view showing a structure of a driving device of opening and closing member according to an embodiment of the present invention;

FIG. 2 is a block diagram showing a structure of the driving device of opening and closing member according to the embodiment of the present invention;

FIG. 3 is a flowchart of a control performed by the driving device of opening and closing member according to a first embodiment of the present invention;

FIG. 4 is a flowchart of a control performed by the driving device of opening and closing member according to a second embodiment of the present invention;

FIG. 5 is a flowchart of a control performed by the driving device of opening and closing member according to a third embodiment of the present invention;

FIG. 6 is a flowchart of a control performed by the driving device of opening and closing member according to a fourth embodiment of the present invention; and

FIG. 7 is a flowchart of a control performed by the driving device of opening and closing member according to a fifth embodiment of the present invention.

### DETAILED DESCRIPTION

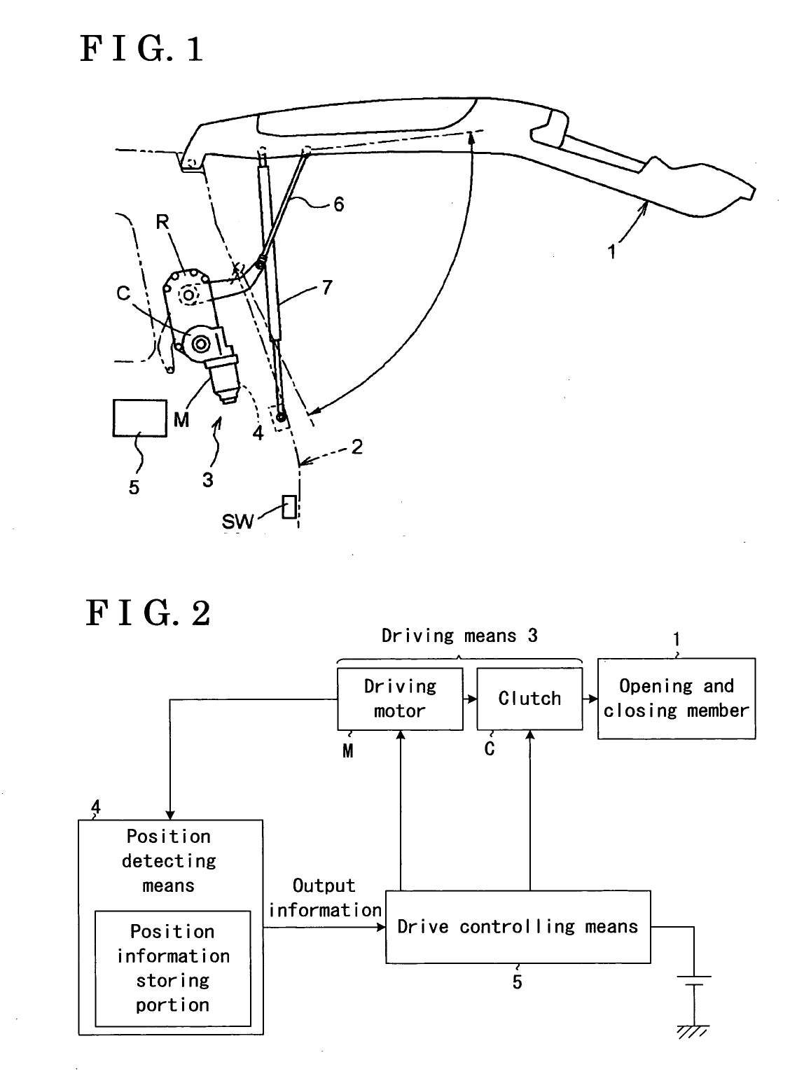

A driving device of opening and closing member according to an embodiment of the present invention is explained with reference to FIGS. 1 and 2. FIG. 1 is a view showing the driving device of opening and closing member employed in a power back door for a vehicle. In FIG. 1, an opening and closing member 1, i.e. the power back door, is in a fully open state. FIG. 2 is a block diagram of the driving device of opening and closing member. The driving device of opening and closing member includes a driving means 3, a position detecting means 4, and a drive controlling means 5 on a vehicle body 2 side. The driving means 3 includes a driving motor M, a rotary encoder serving as the position detecting means 4 arranged adjacent to the driving motor M, and a deceleration mechanism R for adjusting a rotational speed of the driving motor M. The deceleration mechanism R and the back door 1 are connected by an arm member 6. In addition, a dumper 7 is disposed between the back door 1 and the vehicle body 2. The dumper 7 is an air dumper, for example, and assists an opening operation of the back door 1.

Further, a clutch C for engaging or disengaging a connection between the driving motor M and the deceleration mechanism R is arranged adjacent to the driving motor M. The clutch C engages the connection between the driving motor M and the deceleration mechanism R, i.e. the clutch C is in an engagement state, the driving motor M connects to the back door 1, when the back door 1 is automatically opened or closed. Meanwhile, the clutch C disengages the connection between the driving motor M and the deceleration mechanism R, i.e. the clutch C is in a disengagement state, the driving motor M disconnects to the back door 1, when the back door 1 is manually opened or closed, and the like. The clutch C is also brought in a disengagement state when the drive controlling means 5 is reset. The drive controlling means 5 controls the driving means 3 by using an output from the position detecting means 4. Further, the drive controlling means 5 controls an engagement and disengagement of the clutch C in addition to a control of a rotational angle and a rotational speed of the driving motor M.

Furthermore, a latch switch SW is provided on the vehicle body 2 side (e.g. a portion of which a lower portion of the back door 1 contacts with the vehicle body 2). When the back door 1 is fully closed, the latch switch SW is turned on. Then, the drive controlling means 5, which has received a signal indicating that the latch switch SW is turned on, initializes a position of the back door 1.

Next, a method for safely and surely recovering an automatic control of the back door 1 in cases where the drive controlling means 5 is reset is explained based on each embodiment.

According to a first embodiment, the drive controlling means 5 determines a present position of the opening and closing member 1 by using an output information from the position detecting means 4 after the reset of the drive controlling means 5. Then, the drive controlling means 5 controls a subsequent automatic opening and closing operation of the opening and closing member 1. A term of “after the reset” describes a state in which a function of the drive controlling means 5 once ceases due to a voltage fluctuation or a voltage drop and then recovers. In addition, “output information from the position detecting means 4” includes information indicating whether the opening and closing member 1 is moving or not after the reset of the drive controlling means 5, information indicating a moving speed of the opening and closing member 1, information indicating an acceleration of the opening and closing member 1, information indicating amount of displacement of the opening and closing member 1 after the reset of the drive controlling means 5, and the like, i.e. all information obtained from the position detecting means 4.

The output information after the reset of the drive controlling means 5 is applicable according to the first embodiment. That is, when the drive controlling means 5 is reset, an absolute position information of the opening and closing member 1 so far is lost. However, even after the reset, a relative position information of the opening and closing member 1 is continuously obtained by the position detecting means 4. A present position of the opening and closing member 1 is specified by focusing on the output information after the reset of the drive controlling means 5 according to the first embodiment.

A moving information indicating whether the opening and closing member 1 is moving or not after the reset of the drive controlling means 5 is used according to the first embodiment. The air damper 7 provided between the opening and closing member 1 and the vehicle body 2, includes a function of assisting an opening operation of the opening and closing member 1 as mentioned above. Thus, when the drive controlling means 5 is reset during a movement of the opening and closing member 1 and then the clutch C is brought in a disengagement state, the opening and closing member 1 is capable of opening to a fully open position by means of a biasing force of the damper 7. In this case, a subsequent closing operation of the opening and closing member 1 is automatically driven and then a position of the opening and closing member 1 is initialized when the latch switch SW is turned on in a fully closed position so that the absolute position of the opening and closing member 1 is obtained such as an initial position, and a wrong recognition of a position of the opening and closing member 1 may be promptly corrected.

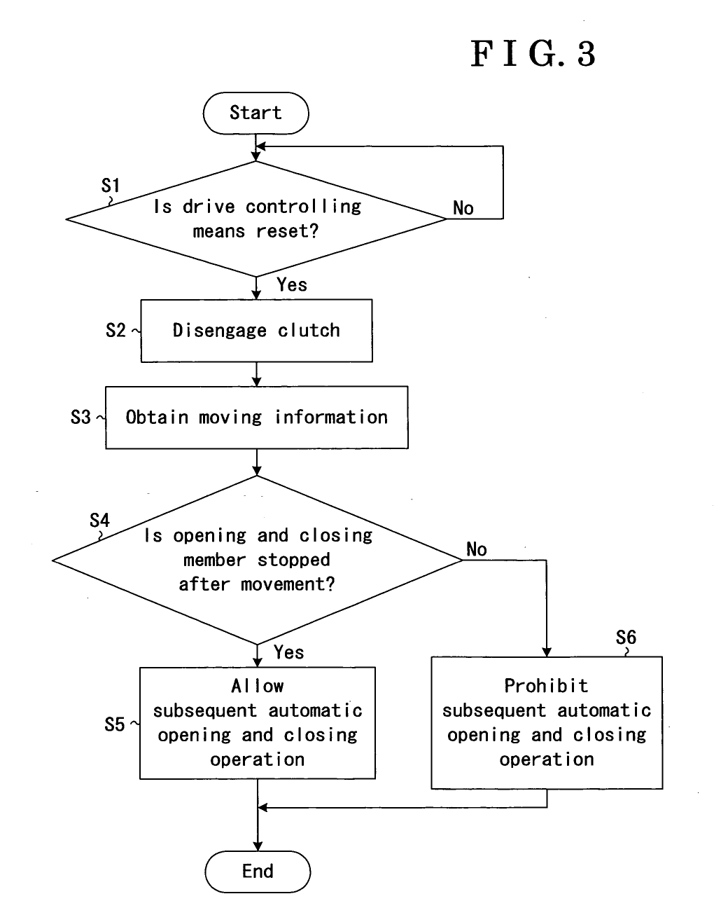

An example of a control flow according to the first embodiment is shown in FIG. 3. First, if it is determined that at least one of circuits of the drive controlling means 5 is reset in Step (hereinafter called “S” for simple explanation) 1, the drive controlling means 5 loses a present position information of the opening and closing member 1. Then, the clutch C is brought in a disengagement state in S2 so that a subsequent automatic opening and closing operation is cancelled. The drive controlling means 5 receives information from the position detecting means 4 after the reset in S3, i.e. moving information of the opening and closing member 1, for example. The moving information, which is one of the output information, shows whether the opening and closing member 1 has moved after the reset of the drive controlling means 5. The moving information is not required to specify an amount of displacement of the opening and closing member 1 after the reset. At this time, information whether the opening and closing member 1 has moved or not, which may be determined on the basis of an amount of displacement or displacement speed, is only required. In S4, if it is determined that the opening and closing member 1 has moved and then stopped after the reset, the drive controlling means 5 determines that the opening and closing member 1 reaches a fully open position and thus allows a subsequent automatic opening and closing operation of the opening and closing member 1 in S5. This allowance is made on the basis of an effect of the damper 7. Meanwhile, if it is determined that the opening and closing member 1 has not moved after the reset in S4, the drive controlling means 5 determines that the opening and closing member 1 is stopped in a middle of a driving area thereof and then prohibits a subsequent automatic opening and closing operation of the opening and closing member 1.

It may be also possible to estimate whether the opening and closing member 1 is in a fully open position by acquiring a speed variation of the opening and closing member 1 as the output information besides the aforementioned moving information. For example, in cases where the opening and closing member 1 moves to open from a fully closed position to a fully open position, a pattern of a speed variation of the opening and closing member 1 may be developed from a relationship between a biasing force of the air dumper 7 and a weight of the opening and closing member 1, and the like. Thus, even if the drive controlling means 5 is reset all of a sudden, it may be determined by monitoring a speed information of the position detecting means 4 after the reset that where the opening and closing member 1 is positioned in the driving area.

The driving device of opening and closing member according to the first embodiment determines a position of the opening and closing member 1 by monitoring the output information from the position detecting means 4 after the reset even if the drive controlling means 5 is reset. With a tentative reference position provided, the opening and closing member 1 is once automatically driven and then a position of the opening and closing member 1 is initialized by a turned on condition of the latch switch SW provided at the vehicle body 2, thereby immediately returning a normal drive controlling state.

Next, according to a second embodiment, a position information of the opening and closing member 1 before the drive controlling means 5 is reset, which is obtained from the position detecting means 4, is used in addition to the aforementioned output information. According to the first embodiment, if the opening and closing member is not operated after the drive controlling means 5 is reset, a subsequent automatic opening and closing operation is not performed. This is to prevent either end portion of the driving area of the opening and closing member 1 from receiving significant load that may be generated if a subsequent automatic opening and closing operation is performed in cases where the opening and closing member 1 is stopped in a middle of the driving area.

However, the opening and closing member 1 may be positioned in the vicinity of a fully open position when the reset of the drive controlling means 5 occurs. At this time, it may be considered that the opening and closing member 1 rarely moves after the reset of the drive controlling means 5. In order to determine such a state properly, a position information of the opening and closing member 1 before the reset is used. That is, as shown in FIG. 2, a position information storing portion is provided in the position detecting means 4 for constantly updating and storing a position information of the opening and closing member 1. Accordingly, a position information of the opening and closing member 1 before the reset occurrence is stored in a nonvolatile memory of position information storing portion. Since the opening and closing member 1 is not operated after the reset, an approximate position of the opening and closing member 1 may be specified by obtaining memory from the position information storing portion.

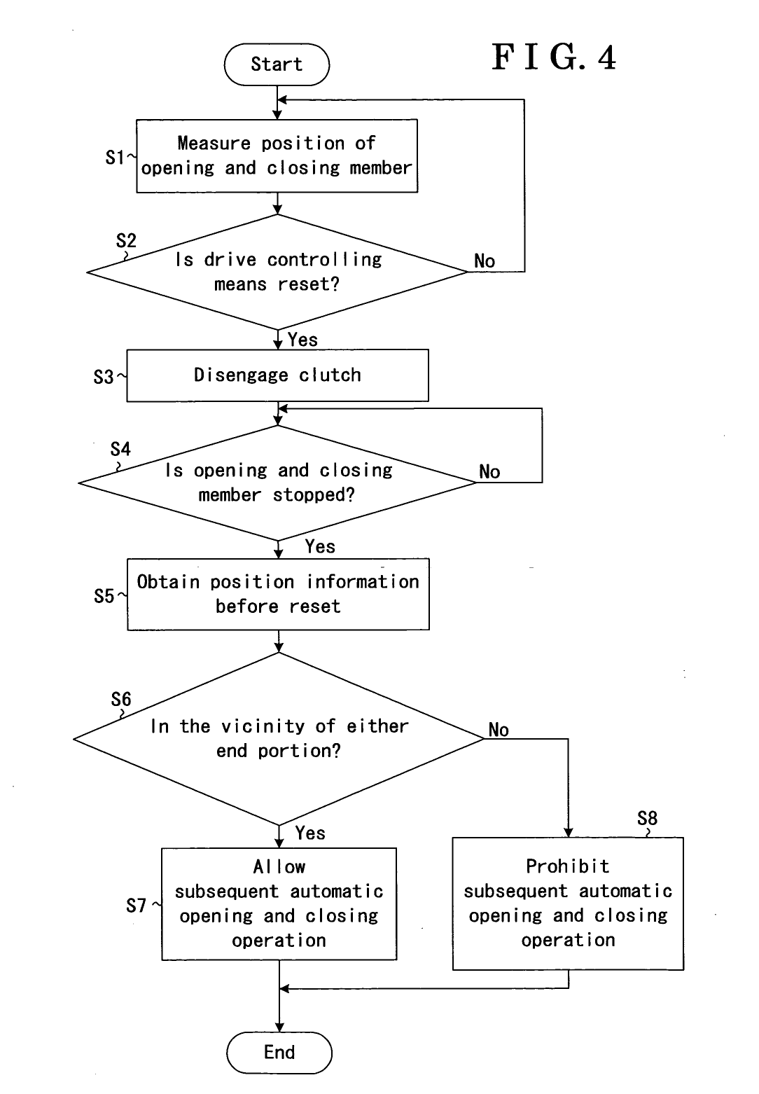

An example of control flow according to the second embodiment is shown in FIG. 4. In this control flow, a position measuring means constantly measures a position of the opening and closing member 1 in S1 based on a relative position information from the position detecting means 4. However, since the latch switch SW periodically initializes a position information, an absolute position information of the opening and closing member 1 is finally acquired. If it is determined that the drive controlling means 5 is reset in S2, then the clutch C is brought in a disengagement state in S3. Next, in S4, the drive controlling means 5 determines, on the basis of a relative moving information from the position detecting means 4, whether the opening and closing member 1 is stopped. When the opening and closing member 1 is determined to be stopped, the driving means 3 obtains, from the position information storing portion, a position information of the opening and closing member 1 before the reset occurrence. If a value of the obtained position information indicates that the opening and closing member 1 is positioned in the vicinity of either end portion in an opening direction or closing direction of the driving area in S6, the drive controlling means 5 allows a subsequent automatic opening and closing operation in S7.

On the other hand, if a value of the obtained position information indicates that the opening and closing member 1 is not positioned in the vicinity of either end portion in an opening direction or closing direction of the driving area in S6, the drive controlling means 5 prohibits a subsequent automatic opening and closing operation in S8. In this control flow, in cases where the opening and closing member 1 is not stopped, the drive controlling means 5 waits until the opening and closing member 1 is stopped in S4. However, when an operation of the opening and closing member 1 is checked in S4, a present flow may be shifted to the control flow of the first embodiment. A present position of the opening and closing member 1 may be further precisely specified by using a position information before the reset occurrence in addition to the output information after the reset.

Next, according to a third embodiment, a displacement information indicating an amount of movement of the opening and closing member 1 after the reset of the drive controlling means 5 is used as the output information. According to the aforementioned second embodiment, a position of the opening and closing member 1 after the reset is specified by considering a position information before the reset occurrence even if the opening and closing member 1 has not moved after the reset. Meanwhile, according to the third embodiment, it is determined whether the opening and closing member 1 is positioned in the vicinity of either end portion of the driving area by acknowledging a moving amount of the opening and closing member 1 after the reset even if a position of the opening and closing member 1 before the reset is unspecified.

The opening and closing member 1 is equipped with the air dumper 7 and thus it may be considered that the opening and closing member 1 tends to stop in the middle of a driving area when the clutch is brought in a disengagement state. This is because a weight of the opening and closing member 1 and a biasing force of the air dumper 7 in the opening direction are balanced out each other and then stopped. However, according to the present embodiment, since the opening and closing member 1 moves after the reset of the drive controlling means 5, it is estimated that the opening and closing member 1 is not positioned in the middle of the driving area any more. In such circumstances, if an amount of displacement of the opening and closing member 1 exceeds a predetermined value, it may be a high possibility that the opening and closing member 1 is positioned in the vicinity of either end portion of the driving area.

For the displacement information, a direction information obtained from the position detecting means 4, i.e. information indicating whether the opening and closing member 1 moves in an opening direction or a closing direction, may be used. In this case, a direction of automatic opening and closing operation for a next initialization may be properly determined, thereby safely and surely performing the automatic opening and closing operation.

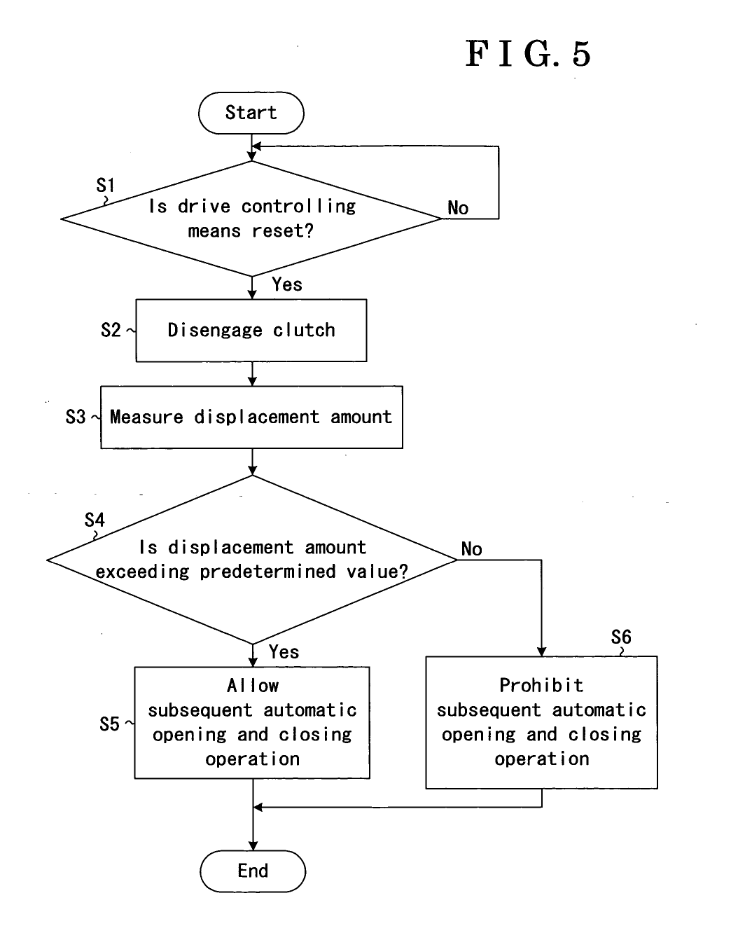

An example of control flow according to the third embodiment is shown in FIG. 5. If it is determined that at least one of circuits of the drive controlling means 5 is reset in S1, then the clutch C is brought in a disengagement state in S2. The drive controlling means 5 obtains a displacement information of the opening and closing member 1 from the position detecting means 4 after the reset of the drive controlling means 5 in S3. The obtained displacement information indicates a moving amount of the opening and closing member 1 after the reset of the drive controlling means 5. Further, this displacement information indicates an amount of relative displacement of the opening and closing member 1 after the reset of the drive controlling means 5. The drive controlling means 5 obtains the displacement information until the opening and closing member 1 is stopped, and then determines whether an amount of displacement exceeds the predetermined value in S4. If it is determined that an amount of displacement exceeds the predetermined value, a subsequent automatic opening and closing operation of the opening and closing member 1 is allowed in S5 since the opening and closing member 1 is determined to be positioned in the vicinity of either end portion of the driving area. On the other hand, if it is determined that an amount of displacement does not exceed the predetermined value in S4, a subsequent automatic opening and closing operation of the opening and closing member 1 is prohibited in S6 since the opening and closing member 1 is determined not to be positioned in the vicinity of either end portion of the driving area. Accordingly, by using the displacement information after the reset, a present position of the opening and closing member 1 may be surely specified.

Next, according to a fourth embodiment, a position information indicating a position of the opening and closing member 1 before the reset of the drive controlling means 5 is used in addition to a displacement information indicating a moving amount of the opening and closing member 1 as the output information after the reset. As mentioned above, a signal from the position detecting means 4 is interrupted for a predetermined period when the drive controlling means 5 is under reset. However, a time period of the reset is normally short and thus a moving amount of the opening and closing member 1 during the reset occurrence is small. Thus, according to the fourth embodiment, an absolute position of the opening and closing member 1 is specified by considering and acknowledging both a position information before the reset of the drive controlling means 5, and a displacement information indicating a moving amount of the opening and closing member 1 after the reset occurrence. Since a time period of which a signal cannot be received from the position detecting means 4 is short, a present position of the opening and closing member 1 may be precisely specified according to the fourth embodiment.

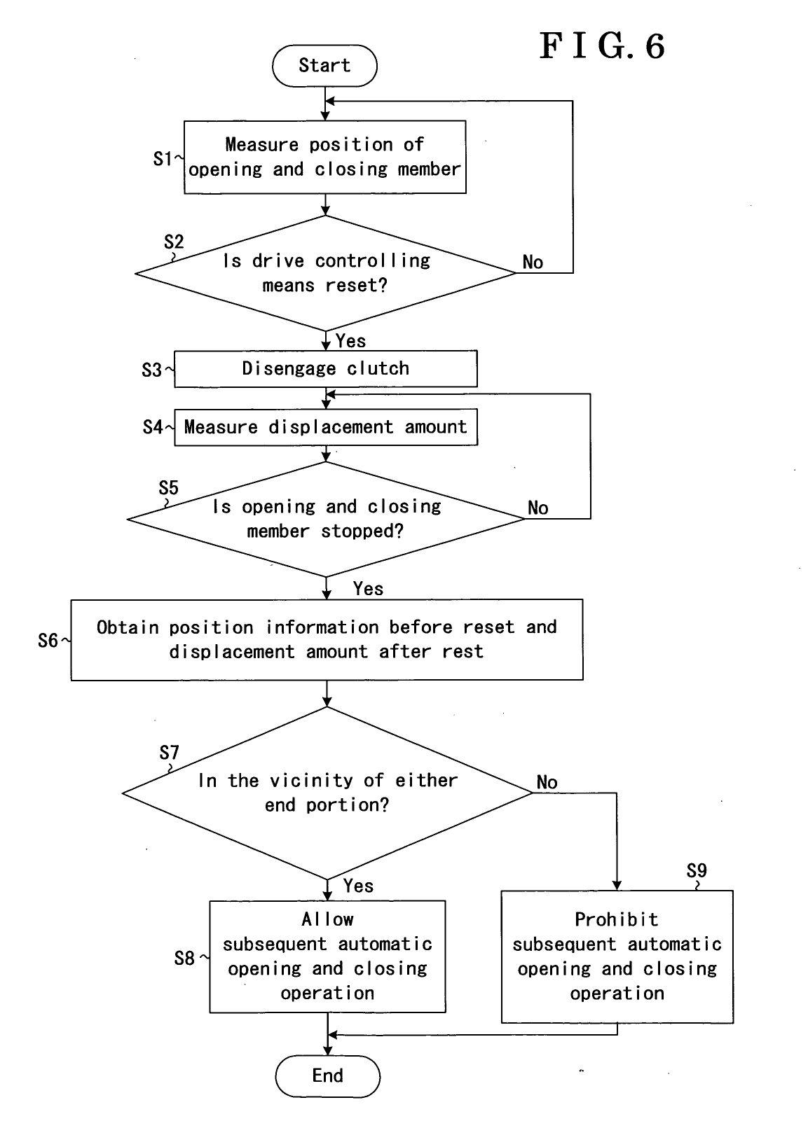

An example of control flow according to the fourth embodiment is shown in FIG. 6. In this control flow, the position measuring means constantly measures a position of the opening and closing member 1 in S1. Then, if it is determined that the drive controlling means 5 is reset in S2, the clutch C is brought in a disengagement state in S3. A position information until the reset occurrence is stored in the position information storing portion in the position detecting means 4.

After the clutch C is brought in a disengagement state, the position detecting means 4 measures an amount of displacement of the opening and closing member 1 and outputs the measured amount of displacement to the drive controlling means 5 in S4. Then, it is determined whether the opening and closing member 1 is stopped on the basis of a moving information obtained from the position detecting means 4 in S5. If it is determined that the opening and closing member 1 is stopped, the drive controlling means 5 obtains a position information before the reset, and an amount of displacement after the reset in S6. Next, the drive controlling means 5 recognizes a total value from the obtained position information and the amount of displacement as an absolute position of the opening and closing member 1, and determines whether the opening and closing member 1 is positioned in the vicinity of either end portion in an opening direction or closing direction of the driving area in S7. If the total value indicates that the opening and closing member 1 is positioned in the vicinity of either end portion in the opening direction or the closing direction of the driving area in S7, the drive controlling means 5 allows a subsequent automatic opening and closing operation of the opening and closing member 1 in S8. On the other hand, if the total value indicates that the opening and closing member 1 is not positioned in the vicinity of either end portion in the opening direction or the closing direction of the driving area in S7, the drive controlling means 5 prohibits the subsequent automatic opening and closing operation of the opening and closing member 1 in S9.

Accordingly, when the drive controlling means 5 is reset, a position of the opening and closing member 1 may be precisely specified. Even while the position of the opening and closing member 1 is initialized, an automatic operation of the opening and closing member 1 may be performed with less inaccuracy.

Next, according to a fifth embodiment, the drive controlling means 5 defines an end portion specifying value as a position information of the opening and closing member 1 in cases where a present position of the opening and closing member 1 is specified to be in the vicinity of either end portion of the driving area.

According to the aforementioned first to fourth embodiments, the opening and closing member 1 is specified to be in the vicinity of either end portion of the driving area. However, an accurate position of the opening and closing member 1 is not specified. That is, an output of the position detecting means 4 during the reset occurrence is not counted, which causes limitations on specifying a precise position of the opening and closing member 1. Thus, for example, when the opening and closing member 1 is automatically operated from a position in the vicinity of a fully closed position to an opening side, the opening and closing member 1 may be driven over a mechanical end portion on a fully open position side.

Therefore, according to the fifth embodiment, if the opening and closing member 1 is specified to be in the vicinity of either end portion of the driving area, the drive controlling means 5 defines the end portion specifying value. The end portion specifying value is desirably defined such that when the opening and closing member 1 is driven from the position in the vicinity of one end portion of the driving area towards the other end portion, an automatic opening and closing operation is stopped before reaching the other end portion. By providing the end portion specifying value, skip of a position detecting information during the reset is corrected and a subsequent automatic opening and closing operation may be smoothly performed. Further, since an excess opening of the opening and closing member 1 is not caused, thereby preventing a breakage of a hinge portion and the like of the opening and closing member 1.

Furthermore, when it is determined that the opening and closing member 1 is presently positioned in the vicinity of a fully open position, a fully open learning value, instead of the end portion specifying value, may be defined. The fully open learning value, which is an output of the position detecting means 4 when the opening and closing member 1 is in a fully open position, is stored in the position information storing portion during the normal automatic opening and closing operation. Since the learning value is specific to the opening and closing member 1 of each vehicle, the learning value may indicate a position of the opening and closing member 1 more precisely than the uniform end portion specifying value.

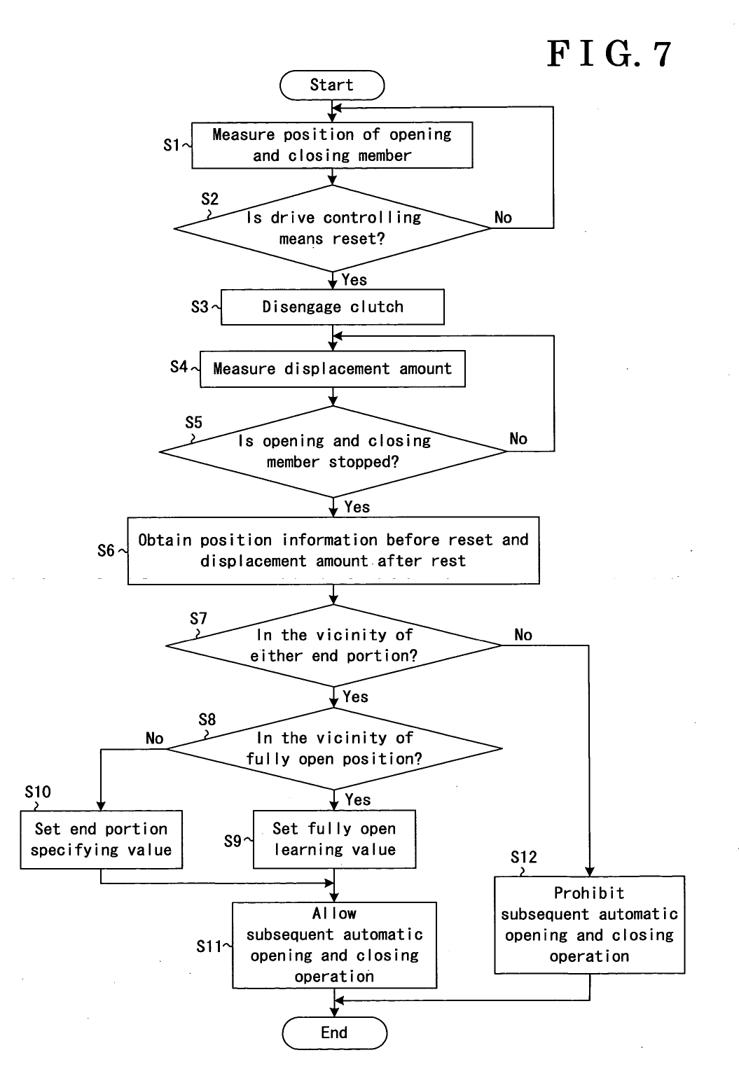

An example of control flow according to the fifth embodiment is shown in FIG. 7. In this control flow, S1 to S7 are same as those in the control flow in FIG. 6 according to the fourth embodiment. A value defined for the drive controlling means 5 after the opening and closing member 1 is positioned in the vicinity of either end portion of the driving area is different between the fourth and fifth embodiments. That is, in cases where the opening and closing member 1 is positioned in the vicinity of a fully opening end portion of the driving area, the fully open learning value is set in S9. In cases where the opening and closing member 1 is not positioned in the vicinity of a fully opening end portion of the driving area, the opening and closing member 1 is determined to be positioned in the vicinity of a fully closed end portion and then the end portion specifying value is set for the drive controlling means 5 in S10. When the fully open learning value or the end portion specifying value is set, a subsequent automatic opening and closing operation is allowed in S11. When the opening and closing member is determined not to be position in the vicinity of either end portion of the driving area, a subsequent automatic opening and closing operation is prohibited in S12.

Accordingly, by providing the end portion specifying value, a counting error of output of the position detecting means 4 during the reset occurrence may be corrected. In addition, since the end portion of the driving area is precisely specified, an operation until the opening and closing member 1 is initialized may be smoothly performed in the same way as the normal automatic opening and closing operation. Further, the end portion of the driving area is precisely specified and thus an excess opening of the opening and closing member 1, for example, may be prevented in cases whether the opening and closing member reverses in the opening direction. Furthermore, by setting the fully opening learning value in cases where the fully open end portion is specified, individual difference of each opening and closing member 1 is absorbed. Thus, the excess opening of the opening and closing member 1 may be prevented and the automatic opening and closing operation may be further smoothly performed.

The driving device of opening and closing member may be employed in a back door, a side door, and the like for a vehicle, for example, that performs an automatic opening and closing operation. In a door automatically opened or closed, an opening or closing position of the door is constantly measured by means of an encoder and the like that is arranged adjacent to a driving motor. Then, the measured value is recognized by an ECU (Electronic control unit) and the like, serving as a drive controlling means, so as to control an opening and closing operation of the door. In case of occurrence of unintentional power supply voltage fluctuation and the like, the ECU may be reset, thereby causing a present position of the door during the driving control to be lost. In such circumstances, an excess external force may be applied to a hinge portion of the door.

According to the aforementioned embodiments, even if the drive controlling means 5 is reset, a present position of the opening and closing member 1 is specified so that a subsequent automatic opening and closing operation is performed. The driving device of opening and closing member is equipped with the latch switch SW, for example, so as to correctly recognize a present position of the opening and closing member 1. Accordingly, if malfunction occurs in an automatic opening and closing operation, while the drive controlling means 5 is properly initialized, the opening and closing member 1 is safely and surely opened or closed automatically.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A driving device of opening and closing member for automatically controlling the opening and closing member comprising:
a driving means including a driving motor that drives an opening and closing member to open or close, and a clutch disposed between the driving motor and the opening and closing member;
a position detecting means for detecting a [relative] position of the opening and closing member;
a drive controlling means for controlling an operation of the driving means by using an output information from the position detecting means; wherein when the drive controlling means is reset, the clutch is brought in a disengagement state, and the drive controlling means specifies a present position of the opening and closing member by using an output information from the position detecting means after the reset of the drive controlling means so as to control a subsequent automatic opening and closing operation of the opening and closing member.

2. A driving device of opening and closing member for automatically controlling the opening and closing member according to claim 1, wherein the drive controlling means uses a position information, which is obtained from the position detecting means, indicating a position of the opening and closing member before the reset of the drive controlling means, in addition to the output information.

3. A driving device of opening and closing member for automatically controlling the opening and closing member according to claim 1, wherein the output information is a moving information indicating whether the opening and closing member has moved after the reset of the drive controlling means.

4. A driving device of opening and closing member for automatically controlling the opening and closing member according to claim 1, wherein the output information is a displacement information indicating an amount of movement of the opening and closing member after the reset of the drive controlling means.

5. A driving device of opening and closing member for automatically controlling the opening and closing member according to claim 1, wherein when the present position of the opening and closing member is specified to be in the vicinity of either end portion of a driving area of the opening and closing member, the drive controlling means sets an end portion specifying value as a position information of the opening and closing member.

6. A driving device of opening and closing member for automatically controlling the opening and closing member according to claim 5, wherein when a present position of the opening and closing member is specified to be in the vicinity of a fully open position of the opening and closing member, the drive controlling means sets a fully open learning value as the end portion specifying value.

7. A driving device of opening and closing member for automatically controlling the opening and closing member according to claim 1, wherein the drive controlling means measures a moving amount of the opening and closing member after the clutch is brought in a disengagement state, and determines whether the opening and closing member is stopped after moving.

8. A driving device of opening and closing member for automatically controlling the opening and closing member according to claim 2, wherein the drive controlling means determines whether the opening and closing member is positioned in the vicinity of either end portion of a driving area based on position information of the opening and closing member before and after the reset of the drive controlling means.

9. A driving device of opening and closing member for automatically controlling the opening and closing member according to claim 1, wherein the drive controlling means sets an end portion specifying value based on whether the opening and closing member is in the vicinity of a fully open position.

10. A driving device of opening and closing member for automatically controlling the opening and closing member according to claim 1, wherein the opening and closing member is a back door for a vehicle.
